(19) United States
(12) Patent Application Publication
(10) Pub. No.: US 2022/0065581 A1
(43) Pub. Date: Mar. 3, 2022

(54) TWO PISTON EJECTION DEVICE

(71) Applicant: Andreas Zournatzis, Drama (GR)

(72) Inventor: Andreas Zournatzis, Drama (GR)

(21) Appl. No.: 17/462,240

(22) Filed: Aug. 31, 2021

(30) Foreign Application Priority Data
Sep. 3, 2020 (GR) 20200100534

(51) Int. Cl. F41B 11/83; F41B 7/04

(52) U.S. Cl. CPC F41B 11/83; F41B 7/04

(57) ABSTRACT

The invention refers to a new ejection order of spears or arrows which functions with compressed air and can be applied to spearguns and crossbows as well.

Two piston ejection device which consists of two air chambers (A) and (B). These air chambers are connected so that they can exchange gases. Air chamber's (B) external hole is open. The characteristic is that pistons (1) and (2) move in air chambers (A) and (B). Pistons (1) and (2) are also connected with the rope (3).

### FIELD OF INVENTION

The invention is about a new device of ejecting spears or arrows which functions with compressed air and consists of two pipes and two pistons, of different diameter, that are connected. This specific disposition can be applied to spearguns and crossbows as well.

### BACKGROUND ART

Pneumatic and band spearguns comprise older, typical techniques.

Pneumatic spearguns consist of a handle that contains a trigger, a pipe that contains compressed air and another pipe of smaller diameter that contains a piston which puts a spear into motion. Band spearguns consist of a handle, a trigger, a pipe, a head and a band that put a spear into motion.

The disadvantage of pneumatic spearguns is that the spear is placed into the pipe of the speargun. This makes shooting difficult because the user can't see the spear in order to use it as shooting line. During pneumatic loading the spear penetrates the pipe and water works in between the inner part of the pipe and the spear. As a result, the piston also gives energy to the water that has penetrated during ejection. That's why pistons of bigger diameter than 13 mm are not used. Thus, air of high pressure comes in the speargun perforce. In addition, pneumatic loading is difficult because force is applied by only one hand due to the disposition of its components. The drawback of band spearguns is the little energy bands give to the spear compared to their size. Moreover, bands have high hydrodynamic resistance during shooting and speargun removal in the water.

### SUMMARY

The purpose of this invention is to create a pneumatic speargun with a new ejection device. The spear will be placed above the pipe. Moreover, the piston's diameter will be more than 13 mm. As a result, it will operate with low pressure air and the spearguns loading will be accomplished by using both hands.

According to the invention, this can be achieved thanks to two air chambers (A) and (B) of different diameter that are connected (FIG. 1). Pistons (1) and (2) can move in these air chambers. Both pistons (1) and (2) have respectively different diameter and are also connected with the rope (3).

According to this invention, a pneumatic speargun has many advantages. Given the fact that the spear is placed above the pipe, it can be used as shooting line. The use of a piston of diameter more than 13 mm entails the function of the speargun with low pressure air. The speargun loading can be achieved by both hands and bigger amount of energy is stored.

The use of ropes to attain spear ejection involves high efficiency because of their small hydrodynamic resistance.

### BRIEF DESCRIPTION OF DRAWINGS

The invention is described below with the help of an example. Reference is also made to the attached design, in which:

FIG. 1 depicts the ejection device of both pistons.

FIG. 2 depicts the ejection device of both pistons added to a speargun that is not loaded.

FIG. 3 depicts the ejection device of both pistons added to a speargun that is loaded.

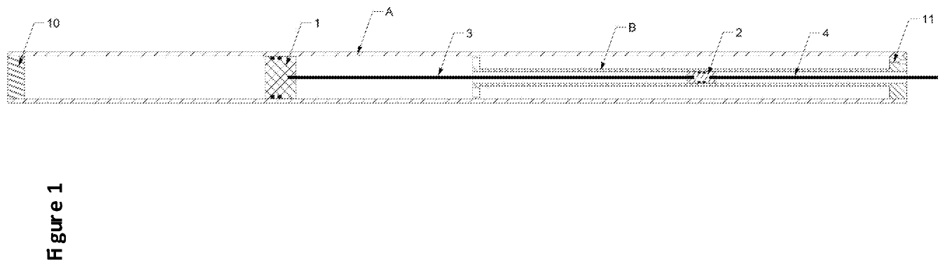

### DETAILED DESCRIPTION OF THE INVENTION

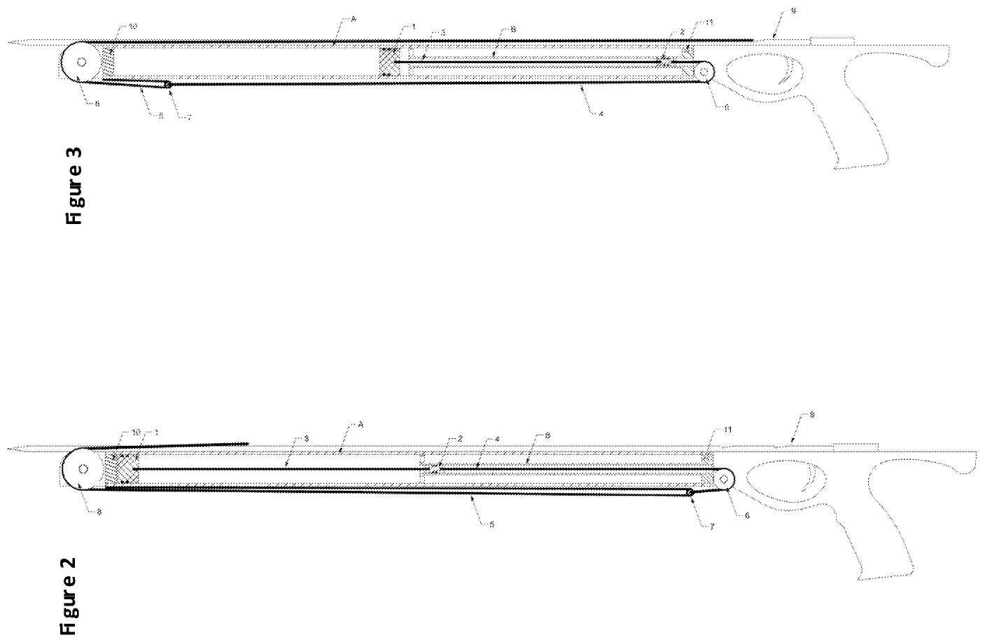

The ejection device of both pistons added to a speargun is described in the example and FIG. 2 as well. We can see air chamber (A) which has bigger diameter than air chamber (B). Air chamber 1 is made water resistant by its left side with the cap (10). On its right side, it is made water resistant by the external perimeter of the right side of the chamber (B). The cap (10) is removable. Air chamber (A) encloses air chamber (B). Air chamber (B) has smaller diameter than air chamber (A). Air chamber (B) can exchange gases with air chamber (A) on its left side, while it is open on its right side.

Piston (1), which has bigger diameter than piston (2), is moving in the air chamber (A). The route of the piston begins from the cap (10) to the middle of the air chamber (A), to the point where air chamber (B) reaches. Piston (2), which has smaller diameter than piston (1), is moving in air chamber (B). The route of piston (2) is the whole length of the air chamber (B). Pistons 1 and 2 are connected with the rope (3). Piston 2 is connected with the rope (4) as well. It is led through the stable pulley (6) and is connected with the free pulley (7). The free pulley (7) is connected with the rope (5), which is led through the stable pulley (8) and connected with the spear (9).

Air comes in air chamber (A) with pressure (10-30 atmospheres) through the valve (11) with an external pump. Once the air comes in, the only way of escape is just through valve (11) because air chambers (A) and (B) are made water-resistant by pistons (1) and (2).

When the speargun is not loaded (FIG. 2) piston 1 is at the beginning of its route, which is cap (10). It has removed piston (2) to its initial position through the rope (3). That's the point where the two air chambers exchange gases. Piston 1 can remove piston 2 because its diameter is bigger and its surface receives totally greater force from air pressure.

Force must be applied to the rope (5) by both hands until they get it to the groove of the spear (9) in order to have the speargun loaded (FIG. 3). As the rope (5) is drawn during loading, it draws through the stable and free pulleys (8),(7),(6) the rope (4), which is connected with piston (2), that pulls piston (1) with the rope (3) to the end of its route.

Once the speargun loading is completed, air chambers (A) and (B) have higher air pressure and bigger energy level than before. The shot-ejection—will take place when the user pulls the trigger and the spear is released (9). Then, piston (1) moves to cap (10), due to the power it receives from the air that is under pressure, by pulling piston (2) through the rope to its initial position. While piston (2) receives power as well from the air which is under pressure, it moves to the opposite direction because the power it receives from piston (1) is bigger, as it has larger surface. Piston (2) pulls free pulley (7) through the rope (4) and the fixed pulley (6). The free pulley pulls the rope (5), which moves and ejects the spear (9) through the fixed pulley (8).

1. An ejection device comprising:
a air chamber (A) and a air chamber (B) which are connected to each other so as to exchange air,
a piston (1) and a piston (2) which moving in said air chambers (A) and (B),
a rope (3) connecting to said piston (1) and piston (2).

2. The ejection device as in claim 1, wherein
said piston (1) and piston (2) are of different diameters.

3. The ejection device as in claim 1, wherein
said air chamber (A) and air chamber (B) are of different diameters
said air chamber (B) is surrounded by the air chamber (A)
said air chamber (B) has its outer hole open.

4. The ejection device as in claim 1, wherein
said piston (2) is connected to a rope (4) with which it eject a spear (9).

5. The ejection device as in claim 1, wherein
said piston (2) is connected to said rope (4) which is driven via a fixed pulley (6) and connected to a free pulley (7).

6. The ejection device as in claim 5, wherein
said free pulley (7) is connected to a rope (5) which through a fixed pulley (8) is led to said spear (9).

7. The ejection device as in claim 1, wherein
said air chamber (B) and a cap (10) are removable.

8. The ejection device as in claim 7, wherein
said cap (10) has an air escape valve for any leaks from said piston (1)
said cap (10) has a rubber shock absorber for said piston (1).
